(19) United States
(12) Patent Application Publication
(10) Pub. No.: US 2018/0253759 A1
(43) Pub. Date: Sep. 6, 2018

(54) LEVERAGING USAGE DATA OF AN ONLINE RESOURCE WHEN ESTIMATING FUTURE USER INTERACTION WITH THE ONLINE RESOURCE

(71) Applicant: Microsoft Technology Licensing, LLC, Redmond, WA (US)

(72) Inventors: Zhifeng Deng, Mountain View, CA (US); Mingyuan Zhong, Sunnyvale, CA (US); Dayun Li, Sunnyvale, CA (US); Fan Gao, Santa Clara, CA (US)

(21) Appl. No.: 15/448,156

(22) Filed: Mar. 2, 2017

(51) Int. Cl. G06Q 30/02; G06Q 10/06

(52) U.S. Cl. CPC G06Q 30/0254; G06Q 10/067; G06Q 30/0243

(57) ABSTRACT

Techniques are provided for building a unified model for selecting content items of different types in response to receiving electronic content requests transmitted over a network. In one technique, in response to a request, multiple content items are identified. The multiple content items include a first content item of a first type and a second content item of a second type. A first engagement value that indicates a first level of engagement of an online resource for content items of the first type is determined. A first predictive user selection rate is generated for the first content item based on the first engagement value. A second predictive user selection rate is generated for the second content item. The multiple content items are ranked based, at least in part, on the predictive user selection rates. A particular content item is then selected based on the predictive user selection rates.

### TECHNICAL FIELD

The present disclosure relates to electronic content delivery over computer networks, and, more particularly, to tracking usage data of an online resource to estimate future user interaction with the online resource. SUGGESTED ART UNIT: 2447. SUGGESTED CLASSIFICATION: 709/200.

### BACKGROUND

The Internet allows end-users operating computing devices to request content from many different content providers. Some content providers desire to send additional content items to users who visit their respective websites or who otherwise interact with the content providers. To do so, content providers may rely on a content delivery service that delivers the additional content items over one or more computer networks to computing devices of such users. Some content delivery services have a large database of content items from which to select. While many content delivery services focus on user relevance when selecting content items for display, other factors may be considered, such as whether a content item is likely to result in future interactions (at least indirectly) with the content delivery service. However, determining such a factor requires collecting and tracking historical online activity of multiple computing devices.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

In the drawings:

FIG. 1 is a block diagram that depicts a system for distributing content items to one or more end-users, in an embodiment;

FIG. 2 is a flow diagram that depicts a process for responding to a request for content, in an embodiment;

FIG. 3 is a block diagram that illustrates a computer system upon which an embodiment of the invention may be implemented.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### Content Item Selection

A database of content items that may be selected for display may contain thousands or tens of thousands of content items. In contrast, the number of content items that could be displayed in response to a single request from a computing device of a user is very few (e.g., five to ten). Because of this large disparity, intelligent techniques should be implemented to display the most relevant and interesting content items to the user.

In many cases, the number of relevant content items that are identified for a user can still be much greater than the available real estate on the user's computing device in which to display the content items. In those cases, the relevant content items are ranked based on one or more factors. One factor may be predictive user selection rate or predictive click-through rate (CTR). Predictive CTR of a content item refers to the likelihood that the content item, if displayed, will be selected (or clicked) by a user. Predictive CTR of a content item may vary at any one time based on numerous factors, such as the specific user, the type of computing device that initiated the content request, the time of day, the day of week, and the type of content on the web page that will display the content item. For example, some users tend to click on more content items than other users. As another example, users of desktop computers tend to click on more content items than users of other types of computing devices (e.g., smartphones). As a further example, more user selections may occur on a weekday than on a weekend.

Calculating an accurate predictive CTR may involve using a prediction model that is based on numerous features, such as those factors mentioned above, including characteristics and/or identity of the user, time of day, etc. The prediction model may or may not be a machined-learned model that is trained based on actual CTRs (not predictive CTRs) of different content items that have been displayed in the past.

However, no matter how accurate a prediction model, there is always bias in the model. To compound the problem, because each type of content item has its own prediction model, the different biases are of a different scale, which makes the predictive CTRs of different types of content item incomparable. Thus, if content items of different types were in the same pool of content items from which to select for display, then content items of a first type may be selected much more often than content items of a second type due to a strong positive bias in the prediction model for the first type of content item.

### Types of Content Items

Example types of content items include text content items, dynamic content items, and third-party content items. Text content items are content items that, when selected (or “clicked”), cause the selecting users (or, rather, their respective computing devices) to be directed to another website. For example, a text content item includes a uniform resource locator (URL) that refers to a domain that is different than the domain of the website that is presenting the text content item.

Dynamic content items are content items that, when selected (or “clicked”), cause the selecting users (or, rather, their respective computing devices) to be directed to another page on the website. The other page may be a “company page” that includes information about the content provider that provided (or originated) the selected content item or about the good, service, or other information referenced in the selected content item.

Additionally or alternatively, dynamic content items may be formatted differently than text content items, may include user-specific information, and/or can be generated based on session context, such as the specific web page or content that a user is viewing or has requested.

Third-party content items are content items that are provided through a third-party service that receives the content items from content providers, similar to a content delivery service described in detail herein. The content delivery service receives the third-party content items from the third-party service and may select such content items for display in place of text content items and/or dynamic content items.

### Approach for Displaying Content Items of Different Types

One approach for addressing the bias problem is to limit the display of content items to a single type for each individual content request. Thus, for example, for one day of requests, only content items of a first type are selected for display and for another day of requests, only content items of a second type are selected for display. As a similar example, for some requests on a particular day, only content items of a first type are selected for display and for other requests on the particular day, only content items of a second type are selected for display.

In either example, for an individual request, if content items of the first type are not selected for display (e.g., due to lack of relevance), then content items of the second type are considered for display. If content items of the second type are not selected for display, then content items of a third type are considered for display. This is referred to as a “waterfall process” of content item selection. If priorities change (for example, there is a desire to display more content items of a second type than a first type for revenue purposes), then manual changes to software code or configuration files are needed to modify the order of the waterfall process. Another downside to this approach of limiting the pool of candidate content items to a particular type is that content items of different types are prevented from being displayed at the same time.

### General Overview

Techniques are described herein for providing a unified model (for selecting content items of different types) that addresses at least some of the aforementioned challenges. In one technique, a level of engagement of content items (or types of content items) is determined to modify a predictive user selection rate for a particular content item. The level of engagement may be calculated based on a probability that a user will request an online resource if the user is presented with a particular content item. In a related technique, a unified model is created that takes into account actual or observed user selection rate data to modify a predictive user selection rate for a particular content item.

### System Overview

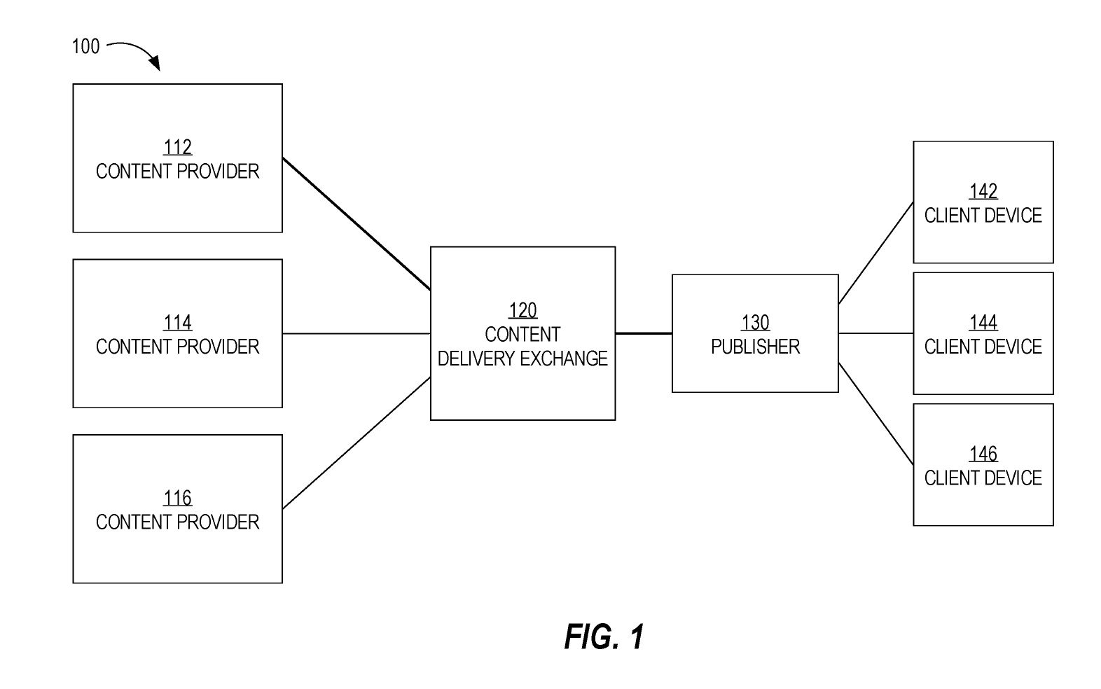

FIG. 1 is a block diagram that depicts a system 100 for distributing content items to one or more end-users, in an embodiment. System 100 includes content providers 112-116, a content delivery exchange 120, a publisher 130, and client devices 142-146. Although three content providers are depicted, system 100 may include more or less content providers. Similarly, system 100 may include more than one publisher and more or less client devices.

Content providers 112-116 interact with content delivery exchange 120 (e.g., over a network, such as a LAN, WAN, or the Internet) to enable content items to be presented, though publisher 130, to end-users operating client devices 142-146. Thus, content providers 112-116 provide content items to content delivery exchange 120, which in turn selects content items to provide to publisher 130 for presentation to users of client devices 142-146. However, at the time that content provider 112 registers with content delivery exchange 120, neither party may know which end-users or client devices will receive content items from content provider 112, unless a target audience specified by content provider 112 is small enough.

An example of a content provider includes an advertiser. An advertiser of a product or service may be the same party as the party that makes or provides the product or service. Alternatively, an advertiser may contract with a producer or service provider to market or advertise a product or service provided by the producer/service provider. Another example of a content provider is an online ad network that contracts with multiple advertisers to provide content items (e.g., advertisements) to end users, either through publishers directly or indirectly through content delivery exchange 120.

Publisher 130 provides its own content to client devices 142-146 in response to requests initiated by users of client devices 142-146. The content may be about any topic, such as news, sports, finance, and traveling. Publishers may vary greatly in size and influence, such as Fortune 500 companies, social network providers, and individual bloggers. A content request from a client device may be in the form of a HTTP request that includes a Uniform Resource Locator (URL) and may be issued from a web browser or a software application that is configured to only communicate with publisher 130 (and/or its affiliates). A content request may be a request that is immediately preceded by user input (e.g., selecting a hyperlink on web page) or may initiated as part of a subscription, such as through a Rich Site Summary (RSS) feed. In response to a request for content from a client device, publisher 130 provides the requested content (e.g., a web page) to the client device.

Simultaneously or immediately before or after the requested content is sent to a client device, a content request is sent to content delivery exchange 120. That request is sent (over a network, such as a LAN, WAN, or the Internet) by publisher 130 or by the client device that requested the original content from publisher 130. For example, a web page that the client device renders includes one or more calls (or HTTP requests) to content delivery exchange 120 for one or more content items. In response, content delivery exchange 120 provides (over a network, such as a LAN, WAN, or the Internet) one or more particular content items to the client device directly or through publisher 130. In this way, the one or more particular content items may be presented (e.g., displayed) concurrently with the content requested by the client device from publisher 130.

Content delivery exchange 120 and publisher 130 may be owned and operated by the same entity or party. Alternatively, content delivery exchange 120 and publisher 130 are owned and operated by different entities or parties.

A content item may comprise an image, a video, audio, text, graphics, virtual reality, or any combination thereof. A content item may also include a link (or URL) such that, when a user selects (e.g., with a finger on a touchscreen or with a cursor of a mouse device) the content item, a (e.g., HTTP) request is sent over a network (e.g., the Internet) to a destination indicated by the link. In response, content of a web page corresponding to the link may be displayed on the user's client device.

Examples of client devices 142-146 include desktop computers, laptop computers, tablet computers, wearable devices, video game consoles, and smartphones.

### Bidders

In a related embodiment, system 100 also includes one or more bidders (not depicted). A bidder is a party that is different than a content provider, that interacts with content delivery exchange 120, and that bids for space (on one or more publishers, such as publisher 130) to present content items on behalf of multiple content providers. Thus, a bidder is another source of content items that content delivery exchange 120 may select for presentation through publisher 130. Thus, a bidder acts as a content provider to content delivery exchange 120 or publisher 130. Examples of bidders include AppNexus, DoubleClick, and Linkedln. Because bidders act on behalf of content providers (e.g., advertisers), bidders create content delivery campaigns and, thus, specify user targeting criteria and, optionally, frequency cap rules, similar to a traditional content provider.

In a related embodiment, system 100 includes one or more bidders but no content providers. However, embodiments described herein are applicable to any of the above-described system arrangements.

### Content Delivery Campaigns

Each content provider establishes a content delivery campaign with content delivery exchange 120. A content delivery campaign includes (or is associated with) one or more content items. Thus, the same content item may be presented to users of client devices 142-146. Alternatively, a content delivery campaign may be designed such that the same user is (or different users are) presented different content items from the same campaign. For example, the content items of a content delivery campaign may have a specific order, such that one content item is not presented to a user before another content item is presented to that users.

A content delivery campaign has a start date/time and, optionally, a defined end date/time. For example, a content delivery campaign may be to present a set of content items from Jun. 1, 2015 to Aug. 1, 2015, regardless of the number of times the set of content items are presented (“impressions”), the number of user selections of the content items (e.g., click throughs), or the number of conversions that resulted from the content delivery campaign. Thus, in this example, there is a definite (or “hard”) end date. As another example, a content delivery campaign may have a “soft” end date, where the content delivery campaign ends when the corresponding set of content items are displayed a certain number of times, when a certain number of users view the set of content items, select or click on the set of content items, or when a certain number of users purchase a product/service associated with the content delivery campaign or fill out a particular form on a website.

A content delivery campaign may specify one or more targeting criteria that are used to determine whether to present a content item of the content delivery campaign to one or more users. Example factors include date of presentation, time of day of presentation, characteristics of a user to which the content item will be presented, attributes of a computing device that will present the content item, identity of the publisher, etc. Examples of characteristics of a user include demographic information, residence information, job title, employment status, academic degrees earned, academic institutions attended, former employers, current employer, number of connections in a social network, number and type of skills, number of endorsements, and stated interests. Examples of attributes of a computing device include type of device (e.g., smartphone, tablet, desktop, laptop), current geographical location, operating system type and version, size of screen, etc.

For example, targeting criteria of a particular content delivery campaign may indicate that a content item is to be presented to users with at least one undergraduate degree, who are unemployed, who are accessing from South America, and where the request for content items is initiated by a smartphone of the user. If content delivery exchange 120 receives, from a computing device, a request that does not satisfy the targeting criteria, then content delivery exchange 120 ensures that any content items associated with the particular content delivery campaign are not sent to the computing device.

Instead of one set of targeting criteria, the same content delivery campaign may be associated with multiple sets of targeting criteria. For example, one set of targeting criteria may be used during one period of time of the content delivery campaign and another set of targeting criteria may be used during another period of time of the campaign. As another example, a content delivery campaign may be associated with multiple content items, one of which may be associated with one set of targeting criteria and another one of which is associated with a different set of targeting criteria. Thus, while one content request from publisher 130 may not satisfy targeting criteria of one content item of a campaign, the same content request may satisfy targeting criteria of another content item of the campaign.

Different content delivery campaigns that content delivery exchange 120 manages may have different compensation schemes. For example, one content delivery campaign may compensate content delivery exchange 120 for each presentation of a content item from the content delivery campaign (referred to herein as cost per impression or CPM). Another content delivery campaign may compensate content delivery exchange 120 for each time a user interacts with a content item from the content delivery campaign, such as selecting or clicking on the content item (referred to herein as cost per click or CPC). Another content delivery campaign may compensate content delivery exchange 120 for each time a user performs a particular action, such as purchasing a product or service, downloading a software application, or filling out a form (referred to herein as cost per action or CPA). Content delivery exchange 120 may manage only campaigns that are of the same type of compensation scheme or may manage campaigns that are of any combination of the three types of compensation scheme.

### Tracking User Interaction

Content delivery exchange 120 tracks one or more types of user interaction across client devices 142-146. For example, content delivery exchange 120 determines whether a content item that exchange 120 delivers is displayed by a client device. Such a “user interaction” is referred to as an “impression.” As another example, content delivery exchange 120 determines whether a content item that exchange 120 delivers is selected by a user of a client device. Such a “user interaction” is referred to as a “click.” Content delivery exchange 120 stores such data as user interaction data, such as an impression data set and/or a click data set.

For example, content delivery exchange 120 receives impression data items, each of which is associated with a different instance of an impression and a particular content delivery campaign. An impression data item may indicate a particular content delivery campaign, a specific content item, a date of the impression, a time of the impression, a particular publisher or source (e.g., onsite v. offsite), a particular client device that displayed the specific content item, and/or a user identifier of a user that operates the particular client device. Thus, if content delivery exchange 120 manages multiple content delivery campaigns, then different impression data items may be associated with different content delivery campaigns. One or more of these individual data items may be encrypted to protect privacy of the end-user.

Similarly, a click data item may indicate a particular content delivery campaign, a specific content item, a date of user selection, a time of the user selection, a particular publisher or source (e.g., onsite v. offsite), a particular client device that displayed the specific content item, and/or a user identifier of a user that operates the particular client device.

User interaction data may be analyzed to calculate a click through rate (CTR) for certain content delivery campaigns, for specific content items within a content delivery campaign (if such a campaign includes or is associated with multiple content items), for specific content providers (that provide or initiate multiple content delivery campaigns), for certain days (e.g., weekends, weekdays in January, and/or holidays that land on Monday), for certain types of content items (e.g., dynamic content items and/or text content items), for individual users or members of an online service associated with content delivery exchange, and/or for certain user segments (e.g., users with certain academic degrees, certain demographic characteristics, certain job titles, and/or a current job status of unemployed).

### Example Process

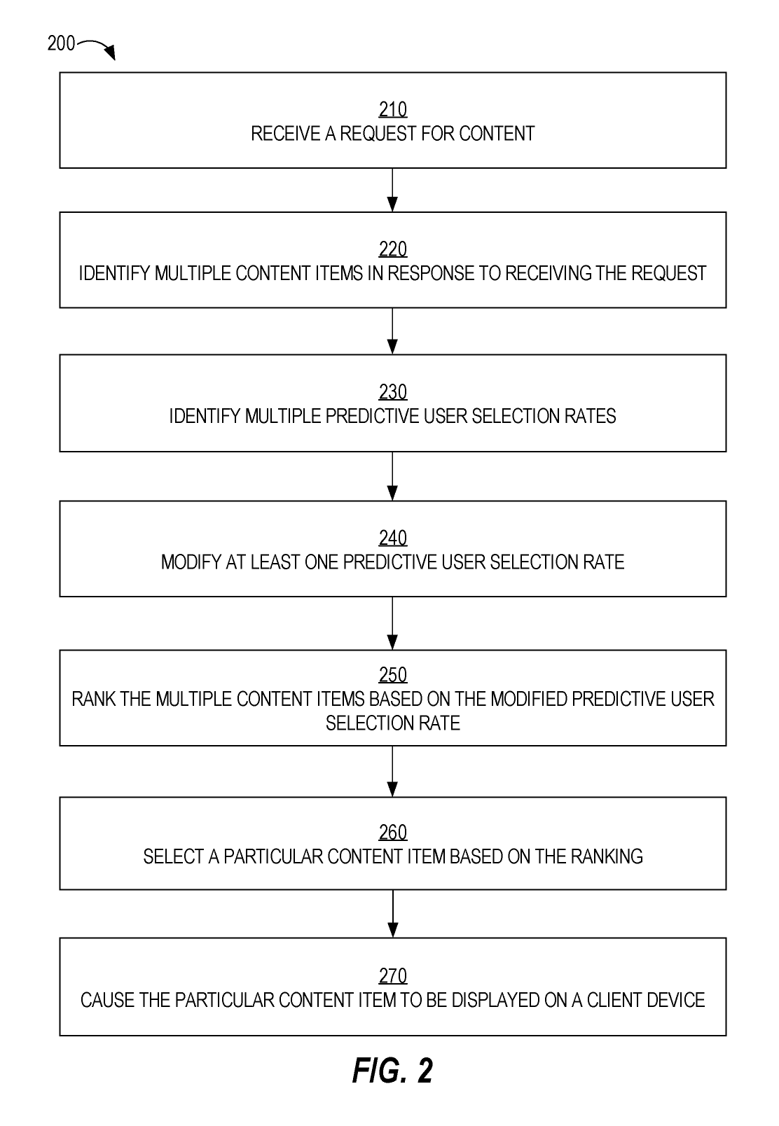

FIG. 2 is a flow diagram that depicts a process 200 for responding to a request for content, in an embodiment. Process 200 may be performed by content delivery exchange 120.

At block 210, a request for one or more content items is received. The request may be for a single content item or for multiple content items. The difference in number of content items may depend on the type of client device and/or other characteristics of the client device. For example, a request that originates from a smartphone may be for one content item while a request that originates from a desktop computer may be for five content items. The difference in number may be due to the size of a screen of the client device, which may vary from one type of client device to another and even from different client devices of the same type. The request triggers a content item selection event where multiple content items are considered and a subset of the content items are selected. An example of a content item selection event is an auction, where a bid price associated with each content item is a factor in selecting a content item for display or transmission.

At block, 220, multiple content items are identified in response to receiving the request. The multiple content items include a first content item of a first type and a second content item of a second type that is different than the first type. For example, the first type may be text content items while the second type may be dynamic or personalized content items.

Block 220 may first involve comparing (1) information known about the user or client device that initiated the request with (2) targeting criteria of different content delivery campaigns. Some targeting criteria may be required to match in order for the corresponding content delivery campaign to be a candidate from which a content item is selected. Some targeting criteria may not be required, but may be used to increase a relevance score of the content delivery campaign.

At block 230, a number of predictive user selection rates are identified. Block 230 may involve generating the predictive user selection rates. Alternatively, the predictive user selection rates may be generated prior to receiving the request. Each identified predictive user selection rate may be for a specific content item that was identified in block 220 or for a content delivery campaign with which a specific content item is associated.

The predictive user selection rates includes (1) a first predictive user selection rate that is generated using a first prediction model that corresponds to the first type and (2) a second predictive user selection rate that is generated using a second prediction model that corresponds to the second type. The different prediction models may be generated based on a different set of features. For example, one prediction model may be based on (a) an identity (or characteristic) of a company of the user whose profile is currently being viewed or requested, (b) a geographic region/location of a profile that is being viewed/requested, and (c) slot size of content items on a particular web page, while one or more other prediction models (e.g., for text content items) do not. Some common features may include an identity of a user that initiated the request, attributes of the user (e.g., employment status, job history, job industry, academic credentials, number of connections, number of recommendations, and other online activity, such as number of posted articles, number of likes of other articles, number of comments on other articles, number of companies following, etc.), attributes of the client device that initiated the request (e.g., IP address, device identifier, type of operating system, type of device), identity of the content provider of the content item, attributes of the content provider (e.g., size of company, attributes of the content item (e.g., a history of user selection of the content item, size of the content item, formatting attributes of the content item), targeting criteria of the corresponding content delivery campaign, and a number of content items (e.g., advertisements) that the corresponding user has viewed/clicked/dismissed.

At block 240, based on the first content item being of the first type, the first predictive user selection rate is modified to generate a modified first predictive user selection rate.

Block 240 may also involve modifying one or more other content items, such as the second content item being of the second type. Each type of content item may be associated with a different amount of modifying. The amount of modifying may vary due to the entity that operates content delivery exchange 120 assigning a different value to each type of content item. Thus, some types of content items are perceived as more valuable than others. Alternatively, instead of relying on subjective perceptions of which content items are more valuable than others, actual user interaction data may be used to calculate an objective value for each type of content item, which objective value indicates a relative value compared to other types of content items.

At block 250, a ranking of the content items is determined based, at least in part, on the modified first predictive user selection rate and the second predictive user selection rate. Another factor upon which the ranking may be based is bid price. Different content items may be associated with different bid prices, which may be established by the content provider that initiated the corresponding content delivery campaign. A bid price may be fixed and unchanged across numerous auctions or may dynamically adjust between auctions. The dynamic adjustment may be based on online activity of the user that initiated the request, how well the content delivery campaign that includes the content item is performed, etc.

At block 260, based on the ranking, a particular content item is selected from among the multiple content items. Block 260 may involve selecting a strict subset (e.g., multiple) of all the content items that are identified in block 220.

At block 270, the particular content item is caused to be displayed on a client device that originated or initiated the request. Block 270 may involve transmitting the particular content item (and, optionally, one or more other content items) over a computer network to the client device.

### Effective Cost Per Impression

Process 200 (e.g., in block 240) may involve calculating an effective cost per impression (eCPI) for each content item identified in block 220. An eCPI for content delivery campaigns that compensate based on whether an associated content item is displayed (i.e., “CPM campaigns”) may be the associated bid / 1000 (referred to as CPM or cost per million impressions for that campaign). An eCPI for content delivery campaigns that compensate based on whether an associated content item is selected or clicked (i.e., “CPC campaigns”) may be the associated bid (referred to as CPC or cost-per-click for that campaign) * predictive user selection rate (hereinafter “predictive CTR”). Predictive CTR (or “pCTR”) is the probability that a content item will be selected or clicked by a user if the content item is displayed to the user.

Block 250 may involve ranking the multiple content items based on their respective eCPI. The content item with the highest CPI is most likely to be selected for display over content items with relatively lower CPIs.

### Machine Learning Approach

In an embodiment, machine learning is used to generate a prediction model that is used to predict user selection rates for different content item. Machine learning is a subfield of computer science that evolved from the study of pattern recognition and computation learning theory in artificial intelligence. Machine learning explores the study and construction of algorithms that can learn from and make predictions on data. Such algorithms operate by building a model from an example training set of input observations in order to make data-driven predictions or decisions expressed as outputs, rather than following strictly static program instructions.

Machine learning is employed in a range of computing tasks where designing and programming explicit algorithms is unfeasible. Example applications include spam filtering, optical character recognition (OCR), search engines and computer vision.

Within the field of data analytics, machine learning is a method used to devise complex models and algorithms that lend themselves to prediction. These analytical models allow researchers, data scientists, engineers, and analysts to “produce reliable, repeatable decisions and results” and uncover “hidden insights” through learning from historical relationships and trends in the data.

Any machine learning technique may be used to generate the prediction model, such as regression, which includes linear regression, ordinary least squares regression, and logistic regression.

In an embodiment, the prediction model is generated based on a training set that includes data from each of multiple content delivery campaigns, including actual (previous) user selection rates and one or more attributes or characteristics of the content delivery campaigns and/or content items associated with the actual user selection rates. Example attributes or characteristics include historical data, campaign type, geography of targeted audience, day of the week of the predicted resource usage, industry associated with the campaign, and characteristics of users in the target audience. The prediction model is used to generate, for a particular content item or content delivery campaign, a prediction of a user selection rate given metadata of the request (e.g., day of the week, holiday status, time of day) and a set of characteristics of the user, the client device (e.g., current geographic region), and the particular content item (or associated campaign), even though the exact characteristics of the particular content delivery campaign may not have been shared with any content delivery campaign upon which the mathematical model is based. A predictive user selection rate of a content item or content delivery campaign may be calculated in response to each request (i.e., “on-the-fly”), or periodically, such as hourly or daily, in order to keep response latency to a minimum.

In an embodiment, multiple prediction models are generated. For example, as noted herein, a different prediction model may be generated for each type of content item that content delivery exchange 120 serves. As another example, content delivery campaigns of one campaign type (e.g., CPM campaigns) and another prediction model may be generated for content delivery campaigns of another campaign type (e.g., cost per click or CPC) one prediction model may be generated for content delivery campaigns of one campaign type (e.g., CPM campaigns) and another prediction model may be generated for content delivery campaigns of another campaign type (e.g., cost per click or CPC). As another example, one prediction model is generated for content delivery campaigns associated with one industry (e.g., related to software services) and another prediction model is generated for content delivery campaigns associated with another industry (e.g., related to financial services). As another example, one prediction model is generated for content delivery campaigns whose target audience is in one geographic region (e.g., the United States) and another prediction model is generated for content delivery campaigns whose target audience is in another geographic region (e.g., India). As another example, one prediction model is generated for campaigns for which historical data is available or there is sufficient user interaction data (e.g., more than 5 days) and another prediction model is generated for content items or content delivery campaigns for which no historical data is available or there is insufficient user interaction data (e.g., less than 6 days of actual usage data).

If multiple prediction models are generated, then process 200 may involve selecting the appropriate prediction model based on one or more characteristics of a content delivery campaign. Since content items may be provided in response to content delivery exchange 120 receiving a request, each content item corresponding to a different content delivery campaign, then multiple prediction models may have been leveraged (either prior to the request or in response to the request) to generate predictions of user selection rates corresponding to the different content delivery campaigns. For example, model M1 is used to generate a prediction for campaign C1, model M2 is used to generate a prediction for campaigns C2 and C3, and model M3 is used to generate a prediction for campaign C4. Then, a content item from each of the four campaigns is provided to a client device in response to a single request.

If a prediction model is generated based on data from multiple content delivery campaigns that share a common set of one or more attributes or characteristics (e.g., campaign type, industry, geography, etc.), then that set of one or more attributes or characteristics are not used as feature(s) when training the prediction model or when using the prediction model to make a prediction.

### Observed CTR

A problem with relying just on predictive CTR is that predictive CTR is only a prediction and there may be a significant gap or difference between the predictive CTR and the actual CTR at any given moment. “Observed” CTR (“oCTR”) is a measure of the actual CTR over a period of time, such as the last minute, the last three hours, the most recent 24 hours, or the last 30 days. Thus, oCTR can be calculated after a content delivery campaign (or specific content item) is actually served. Ideally, the oCTR of a content delivery campaign (or a specific content item) will converge to a certain value as the number of impressions increases. However, user interests and trends are sometimes unpredictable. Thus, some content items may experience a sudden increase in being selected and other content items may experience a sudden decrease.

With pCTR and oCTR, “O/E” is defined as the observed to expected ratio. If the predictive statistical model that is used to calculate a pCTR is accurate enough, then O/E should be equal to 1.0. However, user preferences change over time so, significant changes in oCTR may precede significant changes in pCTR.

### Modifying a Predictive CTR

As described previously, no matter how accurate a prediction model is, there is always bias in the prediction model. Because each type of content item relies on a different predictive model, the biases among the various prediction models will likely be different.

In an embodiment, (e.g., at block 240 in FIG. 2), the predictive CTR (“pCTR”) of a particular content item is modified by the oCTR of the particular content item. The modification may vary based on how much information is available from the oCTR. For example, the greater the number of impressions and/or clicks, the more heavily the oCTR is weighted relative to the pCTR. In other words, a posterior CTR may be calculated as a weighted sum of the pCTR and oCTR. The less the information to calculate oCTR, the higher the weight on pCTR and the lower the weight on oCTR.

In a related embodiment, Bayesian inference is used to calculate a CTR that is neutral to the biases of the different prediction models. Bayesian inference is a method of statistical inference in which Bayes' theorem is used to update the probability for a hypothesis as more evidence or information becomes available. Under this method, a pCTR of a content item is considered a prior CTR. The prior probability of an event or an uncertain proposition is the unconditional probability that is assigned before any relevant evidence is taken into account.

Then, oCTR data is used as evidence to update the CTR in order to calculate a posterior probability. The oCTR data may comprise user interaction data pertaining to the content item, the content delivery campaign, and/or one or more content items of other content delivery campaign(s). The “posterior probability” of an event or an uncertain proposition is the conditional probability that is assigned after the relevant evidence or background is taken into account.

An example formula for calculating a posterior CTR is as follows:

posterior CTR=((prior CTR*suppose)+clicks)/(suppose+impressions)

where “prior CTR” is the pCTR, “suppose” is a predefined constant that can be tuned, and “clicks” and “impressions” are observed values from user interaction data. Then, in ranking (e.g., block 250 in FIG. 2), posterior CTR replaces pCTR. Then, eCPI for CPC campaigns becomes:

$$\begin{matrix}e C P I = bid * posterior C T R \\ = bid * ( ( p C T R * suppose ) + clicks ) / ( suppose + impressions )\end{matrix}$$

### Engagement Value

In an embodiment, an engagement value is determined for one or more content items. An engagement value indicates a level of engagement of an online resource for a content item. The higher the engagement value of a content item, the higher likely a display or selection of the content item will lead to future engagement of (or interaction with) the online resource. Thus, an eCPI may be modified based on an engagement value. Engagement value consideration is a specific example of block 240, where a predictive user selection rate is modified.

In an embodiment, an engagement value is determined on a content item type basis. Generally, each type of content item may cause a different level of engagement. For example, some types of content items (e.g., text content items) cause website visitors to be directed to other websites while other types of content items (e.g., dynamic content items) cause website visitors to stay within the website through which the content items are displayed.

In a related embodiment, an engagement value is determined for a different category (e.g., a finer-grained category) than type of content item. Example categories include content items from a certain content item provider; content items related to a certain subject matter or type of information, good, or service (e.g., job openings, vacation rentals, enterprise solutions for data storage or data security); content items having certain characteristics (e.g., certain height, width, or total area, certain color combination, certain font size and/or color, and certain types of graphics); content items that target a certain user segment or demographic; and content items that link to one or more particular web pages, web content, or type of web content.

Examples of content items related to certain subject matter include “follow company” (where user selection causes content from the corresponding company or organization to be automatically inserted into the user's content feed), “work with us” (where user selection causes information about a particular job opening and/or the corresponding organization to be inserted into the user's content feed), “company spot light” (where user selection causes a page about recent updates related to a company to be displayed), and “picture yourself” (where user selection causes a job page that a particular company posted to be displayed). Each of these different subject matter may be considered subtypes of dynamic content items and may be formatted differently from each other. Thus, each subtype may be associated with a different engagement value.

Examples of content items that include a link (e.g., a hyperlink) to a particular web page, web content, or type of web content include content items that link to a home page of a particular website, content items that link to a user profile page, content items that link to a company profile page, content items that link to a job board page, content items that link to a search page, etc. Distinguishing among these types of linked-to content may be useful if some linked-to content is valued over other linked-to content.

### Engagement Value Determination

In an embodiment, an engagement value is set based on a subjective perception of the value of a type of content item relative to other types of content items. Thus, a user or administrator of content delivery exchange 120 establishes one or more engagement values. For example, dynamic content items have an engagement value of 1.1 while other types of content items have an engagement value of 1.0. When modifying an eCPI for a content item, the eCPI is combined with (e.g., may be multiplied by or summed with) engagement value m. For example, eCPI′=eCPI*m.

In an alternative embodiment, an engagement value is calculated based on usage or visit data that indicates when users requested an online resource, such as a specific web page, a specific set of web pages (from the same website or from different websites), a website comprising multiple web pages, or a set of websites. For example, usage data may indicate that:
user A requested page 1 on at time M
user B requested page 2 at time N
user A requested page 1 on at time O
user A requested page 3 on at time P
   The usage data may also indicate which content items were displayed to user A on page 1 and whether user A selected any of those content items.

An example formula for calculating such an engagement value m is as follows:

m=1/(1−X*p)

where X is a tunable constant and p is P(visit|click)/P(visit|non-click).

p may be unique for each type of content item and pre-computed from data analysis. P(visit|click) refers to a probability of users requesting an online resource (e.g., visiting a website) after clicking on a particular content item (or particular type of content item) that was displayed to the users. In the latter case, usage data may be analyzed to aggregate usage data from all content items of the same particular type. Similarly, P(visit|non-click) refers to a probability of users requesting the online resource after not clicking on a particular content item (or a content item of the particular type) that was displayed to the users. Example time ranges considered for aggregating requests of an online resource (e.g., website visits) include daily, weekly, monthly, a particular work week (i.e., minus weekends), weekends, holiday v. non-holiday, etc.

In an embodiment, the online resource is a website. Thus, a single p value is calculated for the entire website, is used in determining an engagement value, and may be updated from time to time (e.g., daily or weekly). In an alternative embodiment, the online resource is a specific webpage, a specific set of webpages, a particular view (in the case of a smartphone application), or a particular set of views. (For purposes of brevity, references here to “page” also includes a “view” unless otherwise indicated.) Thus, if p is calculated on a per-webpage basis, then many different values of p may be calculated, one p value for each webpage. One reason for calculating a p value for each webpage is if there a significant variance in p values across a website. Conversely, if the variance in p values is relatively small, then utilizing a single p value is sufficient regardless on which page a content item will be displayed.

P(visit|click) may be based on usage data that indicates that user A selected content item C on day M and that user A visited page 3 on day M+1. Even though user A's visit to page 3 was not immediately the result of selecting content item C, the value of P(visit|click) for content item C (or for content items of the same type as content item C) increases, presuming that the time range for associating visits with prior clicks is at least one day. Conversely, if usage data indicates that user B did not request any content (e.g., on a web page or through a smartphone application) of the online resource after selecting content item D on day M for a period of time (e.g., 5 days), then P(visit|click) would decrease for content item D or for content item D's type.

P(visit|non-click) may be based on usage data that indicates that user C requested content (e.g., on a specific web page) from the online resource on day N+1 but did not click on content item E when it was displayed on day N. In this situation, P(visit non-click) increases. Conversely, user D did not request content from the online resource for at least two days since day P when D did not select content item E, which was displayed to user D on day P. In this situation, P(visit|non-click) decreases for content item E (or for content items of the same type as content item E).

Some content delivery campaigns or content items may be new and, therefore, have little to no usage data associated with them. In an embodiment, a regression model is generated is used to estimate a p value for relatively new content delivery campaigns, new content items, or new types of content items. Example features include properties of a content delivery campaign (e.g., demographic information of target audience, duration, success of campaign thus far), properties of a specific content item (e.g., format, size, colors, existence of an image, location of a button, number of clicks of the content item thus far), and properties of a new content type. In order to generate a regression model, the following may be assumed for estimating a p value for a new (or relatively new) content delivery campaign or content item:

p=c^{T}β+ϵ

where c a set or vector of campaign and creative features, β is a set or vector of coefficients, c^{T}β is the inner product between vectors c and β, and ϵ is an error term or noise and contains the variability of the dependent variable not explained by the independent variable. In order to generate the regression model, multiple p values are first calculated (i.e., using the formula above where p=P(visit|click)/P(visit|non-click)), each p value corresponding to a different campaign/content item. Then a regression model is generated by assuming:

p=c^{T}β+ϵ

Training the regression model involves, for example, tuning β until a sum of the predicted loss is minimized. Once the regression model is trained, the above formula for estimating a p value may be used for a new content delivery campaign or content item.

If X is 0, then engagement is negated, indicating that engagement is not a factor in calculating eCPI. The greater the X, the more engagement is a factor in calculating a revised effective cost per impression (or eCPI′).

In an embodiment, X is determined using A/B testing where different values of X are used simultaneously (e.g., for different web pages requests on the same day) to determine which value(s) of X result in better performance. An example of a measure of performance is revenue incurred for the entity that operates content delivery exchange 120. Thus, if Xi results in higher revenue than X₂, then X₁ is selected as the value for X in the formula above.

In an alternative embodiment, X is determined using a regression model that is generated based on (1) user session features, such as properties of a member profile (e.g., job status, industry, highest academic degree) and (2) session properties, such as a page key that uniquely identifies a specific page or a specific type of page (e.g., a home page) from another type of page (e.g., a member's profile page). The regression model for X is generated by assuming:

X=α^{T}β+ϵ

where α is a set or vector of user session features, β is a vector or set of coefficients, α^{T}β is the inner product between vectors α and β, and ϵ is an error term or noise. The training data for the regression model comprises feature values of a set of known users and a set of known pages. Parameters β and ϵ will be determined once the regression model is trained and validated.

If engagement is taken into account when calculating an eCPI′, then an example formula for doing so is as follows:

$$e C P {I}^{′} = e C P I / ( 1 - X * p )$$

$$where$$

$$\begin{matrix}e C P I = bid / 1000 ( for C P M campaigns ) \\ e C P I = bid * posterior C T R ( for C P C campaigns ) \\ = bid * ( ( p C T R * suppose ) + clicks ) / ( suppose + impressions )\end{matrix}$$

where eCPI′ represents a unified model that can be used for content items of multiple types.

### Charging Model

Engagement value represents a positive latent value to the entity that operates content delivery exchange 120. However, such latent value does not benefit content providers that are charged for content delivery exchange 120 delivering and displaying their respect content items. Therefore, it would not be fair for the content providers to be charged for that latent value.

In an embodiment, an amount to charge a content provider is determined by selecting the second revised effective cost per impression (i.e., the second highest ranked eCPI′ for a particular slot in a web document) and removing, from the second eCPI′, the effect of (1) the engagement value, if engagement value was used to calculate eCPI′ for multiple content items in response to the initiating request, and (2) the posterior CTR of the highest ranked (or ultimately selected) content item (referred to herein as “posterior(first CTR)”), if the posterior CTR was calculated for each of multiple content items identified as relevant in response to the initiating request. Option (2) is applicable in embodiments where the content delivery campaign is a CPC campaign. Option (1) is applicable in embodiments where the content delivery campaign is either a CPC campaign or a CPM campaign.

Removal of an engagement value may be performed by multiplying the second eCPI′ by the inverse of engagement value that was calculated for the highest ranked content item (after calculating an eCPI′ for each content item that content delivery exchange 120 identified as relevant in response to the initiating request and that reached the stage where an eCPI is calculated). In some cases, the engagement value for the highest ranked content item will be different than the engagement value for the second highest ranked content item. For example, in embodiments where engagement value is calculated on a content item type basis, the highest ranked content item may be of one type while the second highest ranked content item may be of a different type. Thus, the engagement values of the two highly ranked content items may be different.

In an embodiment, a content provider that established a CPM campaign with content delivery exchange 120 is charged according to the following formula:

$$\begin{matrix}Chargeable cost = second e C P {I}^{′} * ( 1 - X * first p ) \\ = second bid / 1000 * ( 1 - X * first p ) / \\ ( 1 - X * second p )\end{matrix}$$

Removal of posterior(first CTR) may be performed by multiplying (a) the second (non-revised) eCPI by the inverse of the posterior(first CTR) (if the engagement value of the content item was not considered) or (b) the second (revised) eCPI′ by the inverse of the posterior(first CTR) (if the engagement value of the content item was considered).

In an embodiment, a content provider that established a CPC campaign with content delivery exchange 120 is charged according to the following formula:

$$\begin{matrix}Chargeable cost = second e C P {I}^{′} * ( 1 - X * first p ) / \\ posterior ( first C T R ) \\ = second bid * posterior ( second C T R ) / \\ posterior ( first C R T ) * ( 1 - X * first p ) / \\ ( 1 - X * second p )\end{matrix}$$

In an embodiment, a final charge is ensured to always be between the floor price and the bid at issue. An example of a formula to determine a final charge is as follows:

Final Charge=min(max(Chargeable cost, floor price), bid)

### Benefits

Benefits of embodiments described herein include better joint optimization across different types of content items and an easier model to extend when adding a new type of content item to the inventory of available content items. As an example of the latter is if another third-party service wants to bid through content delivery exchange 120, then doing so will be much easier with the unified model. Another benefit is simplifying the content item consolidation layer by removing the need for the waterfall process.

Another benefit is simplifying forecasting and pricing strategies. Currently, forecast and pricing models are built separately for each type of content item. Due to the external complexity inherent in the waterfall process, there is no good way to simulate the interaction between different types of content items. Building a unified model as described herein provides a solid foundation for pricing optimization.

Another benefit is better performance optimization of dynamic content items if dynamic content items are further divided into different subtypes. With a unified model described herein, a latent value of each subtype may be explored and exploited in order to increase the overall value of and/or revenue from dynamic content item campaigns.

### Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

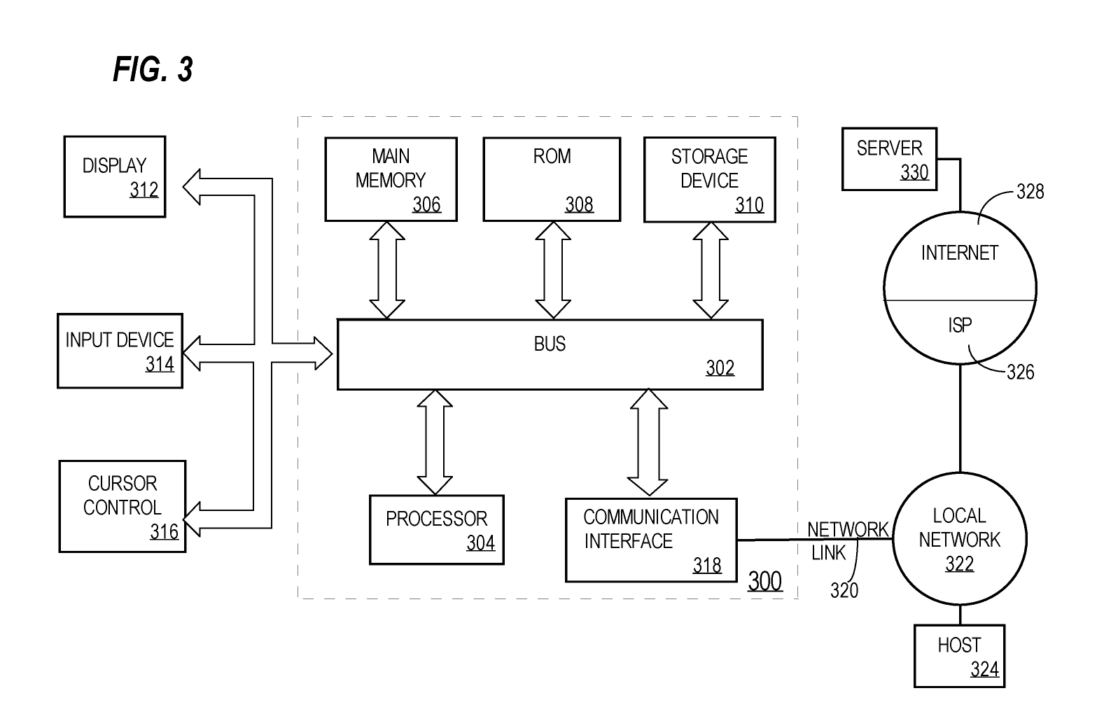

For example, FIG. 3 is a block diagram that illustrates a computer system 300 upon which an embodiment of the invention may be implemented. Computer system 300 includes a bus 302 or other communication mechanism for communicating information, and a hardware processor 304 coupled with bus 302 for processing information. Hardware processor 304 may be, for example, a general purpose microprocessor.

Computer system 300 also includes a main memory 306, such as a random access memory (RAM) or other dynamic storage device, coupled to bus 302 for storing information and instructions to be executed by processor 304. Main memory 306 also may be used for storing temporary variables or other intermediate information during execution of instructions to be executed by processor 304. Such instructions, when stored in non-transitory storage media accessible to processor 304, render computer system 300 into a special-purpose machine that is customized to perform the operations specified in the instructions.

Computer system 300 further includes a read only memory (ROM) 308 or other static storage device coupled to bus 302 for storing static information and instructions for processor 304. A storage device 310, such as a magnetic disk, optical disk, or solid-state drive is provided and coupled to bus 302 for storing information and instructions.

Computer system 300 may be coupled via bus 302 to a display 312, such as a cathode ray tube (CRT), for displaying information to a computer user. An input device 314, including alphanumeric and other keys, is coupled to bus 302 for communicating information and command selections to processor 304. Another type of user input device is cursor control 316, such as a mouse, a trackball, or cursor direction keys for communicating direction information and command selections to processor 304 and for controlling cursor movement on display 312. This input device typically has two degrees of freedom in two axes, a first axis (e.g., x) and a second axis (e.g., y), that allows the device to specify positions in a plane.

Computer system 300 may implement the techniques described herein using customized hard-wired logic, one or more ASICs or FPGAs, firmware and/or program logic which in combination with the computer system causes or programs computer system 300 to be a special-purpose machine. According to one embodiment, the techniques herein are performed by computer system 300 in response to processor 304 executing one or more sequences of one or more instructions contained in main memory 306. Such instructions may be read into main memory 306 from another storage medium, such as storage device 310. Execution of the sequences of instructions contained in main memory 306 causes processor 304 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage device 310. Volatile media includes dynamic memory, such as main memory 306. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 302. Transmission media can also take the form of acoustic or light waves, such as those generated during radio-wave and infra-red data communications.

Various forms of media may be involved in carrying one or more sequences of one or more instructions to processor 304 for execution. For example, the instructions may initially be carried on a magnetic disk or solid-state drive of a remote computer. The remote computer can load the instructions into its dynamic memory and send the instructions over a telephone line using a modem. A modem local to computer system 300 can receive the data on the telephone line and use an infra-red transmitter to convert the data to an infra-red signal. An infra-red detector can receive the data carried in the infra-red signal and appropriate circuitry can place the data on bus 302. Bus 302 carries the data to main memory 306, from which processor 304 retrieves and executes the instructions. The instructions received by main memory 306 may optionally be stored on storage device 310 either before or after execution by processor 304.

Computer system 300 also includes a communication interface 318 coupled to bus 302. Communication interface 318 provides a two-way data communication coupling to a network link 320 that is connected to a local network 322. For example, communication interface 318 may be an integrated services digital network (ISDN) card, cable modem, satellite modem, or a modem to provide a data communication connection to a corresponding type of telephone line. As another example, communication interface 318 may be a local area network (LAN) card to provide a data communication connection to a compatible LAN. Wireless links may also be implemented. In any such implementation, communication interface 318 sends and receives electrical, electromagnetic or optical signals that carry digital data streams representing various types of information.

Network link 320 typically provides data communication through one or more networks to other data devices. For example, network link 320 may provide a connection through local network 322 to a host computer 324 or to data equipment operated by an Internet Service Provider (ISP) 326. ISP 326 in turn provides data communication services through the world wide packet data communication network now commonly referred to as the “Internet” 328. Local network 322 and Internet 328 both use electrical, electromagnetic or optical signals that carry digital data streams. The signals through the various networks and the signals on network link 320 and through communication interface 318, which carry the digital data to and from computer system 300, are example forms of transmission media.

Computer system 300 can send messages and receive data, including program code, through the network(s), network link 320 and communication interface 318. In the Internet example, a server 330 might transmit a requested code for an application program through Internet 328, ISP 326, local network 322 and communication interface 318.

The received code may be executed by processor 304 as it is received, and/or stored in storage device 310, or other non-volatile storage for later execution.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A system comprising:
one or more processors;
one or more storage media storing instructions which, when executed by the one or more processors, cause:
receiving, over a computer network, a request for one or more content items;
in response to receiving the request:
identifying a plurality of content items that includes a first content item of a first type and a second content item of a second type that is different than the first type;
determining a first engagement value that indicates a first level of engagement of an online resource for content items of the first type;
generating, based on the first engagement value, a first predictive user selection rate for the first content item;
generating a second predictive user selection rate for the second content item;
determining a ranking of the plurality of content items based, at least in part, on the first predictive user selection rate and the second predictive user selection rate;
selecting, based on the ranking, a particular content item from the plurality of content items;
sending, over the computer network, the particular content item to be displayed on a client device.

2. The system of claim 1, wherein the instructions, when executed by the one or more processors, further cause:
determining a second engagement value that indicates a second level of engagement of the online resource for content items of the second type;
wherein the first engagement value is different than the second engagement value;
based on the second engagement value, modifying the second predictive user selection rate to generate a modified second predictive user selection rate;
wherein the ranking is also based, at least in part, on the modified second predictive user selection rate.

3. The system of claim 1, wherein the instructions, when executed by the one or more processors, further cause, in response to receiving a second request:
identifying a second plurality of content items that includes a third content item of a third type;
determining a second engagement value that indicates a second level of engagement associated with first content items that contain a link to a first set of content;
generating a second predictive user selection rate based on the second engagement value.

4. The system of claim 3, wherein the instructions, when executed by the one or more processors, further cause:
determining a third engagement value that indicates a third level of engagement associated with second content items that contain a link to a second set of content that is different than the first set of content;
wherein the second engagement value is different than the third engagement value.

5. The system of claim 1, wherein the instructions, when executed by the one or more processors, further cause:
determining a first number of times that users request the online resource after selecting content items of the first type;
determining a second number of times that users request the online resource after not selecting content items of the first type;
generating the first engagement value based on a ratio of the first number of times and the second number of times.

6. The system of claim 5, wherein the instructions, when executed by the one or more processors, further cause:
for a first set of requests, using the first engagement level;
for a second set of requests, using a second engagement level that is different than the first engagement level;
performing a comparison between a first performance of the first set of requests and a second performance of the second set of requests;
selecting a particular engagement level based on the comparison.

7. The system of claim 1, wherein:
the first type is one of text content items, dynamic content items, or third-party content items;
the second type is another of text content items, dynamic content items, or third-party content items.

8. The system of claim 1, wherein:
generating the first predictive user selection rate for the first content item comprises:
generating a first initial predictive user selection rate using a first prediction model that corresponds to the first type, and
modifying the initial predictive user selection rate based on the first engagement level to generate the first predictive user selection rate;
generating the second predictive user selection rate for the second content item comprises
generating the second predictive user selection rate using a second prediction model that corresponds to the second type.

9. The system of claim 8, wherein the first prediction model is based on a first set of features and the second prediction model is based on a second set of features that is different than the first set of features.

10. A system comprising:
one or more processors;
one or more storage media storing instructions which, when executed by the one or more processors, cause:
receiving, over a computer network, a request for one or more content items;
in response to receiving the request:
identifying a plurality of content items that includes a first content item of a first type and a second content item of a second type that is different than the first type;
generating a plurality of predictive user selection rates;
wherein generating the plurality of predictive user selection rates comprises:
generating, using a first prediction model that corresponds to the first type, a first predictive user selection rate, and
generating, using a second prediction model that corresponds to the second type, a second predictive user selection rate;
based on the first content item being of the first type, modifying the first predictive user selection rate to generate a modified first predictive user selection rate;
determining a ranking of the plurality of content items based, at least in part, on the modified first predictive user selection rate and the second predictive user selection rate;
selecting, based on the ranking, a particular content item from the plurality of content items;
sending, over the computer network, the particular content item to be displayed on a client device.

11. A method comprising:
receiving, over a computer network, a request for one or more content items;
in response to receiving the request:
identifying a plurality of content items that includes a first content item of a first type and a second content item of a second type that is different than the first type;
determining a first engagement value that indicates a first level of engagement of an online resource for content items of the first type;
generating, based on the first engagement value, a first predictive user selection rate for the first content item;
generating a second predictive user selection rate for the second content item;
determining a ranking of the plurality of content items based, at least in part, on the first predictive user selection rate and the second predictive user selection rate;
selecting, based on the ranking, a particular content item from the plurality of content items;
sending, over the computer network, the particular content item to be displayed on a client device;
wherein the method is performed by one or more computing devices.

12. The method of claim 11, further comprising:
determining a second engagement value that indicates a second level of engagement of the online resource for content items of the second type;
wherein the first engagement value is different than the second engagement value;
based on the second engagement value, modifying the second predictive user selection rate to generate a modified second predictive user selection rate;
wherein the ranking is also based, at least in part, on the modified second predictive user selection rate.

13. The method of claim 11, further comprising, in response to receiving a second request:
identifying a second plurality of content items that includes a third content item of a third type;
determining a second engagement value that indicates a second level of engagement associated with first content items that contain a link to a first set of content;
generating a second predictive user selection rate based on the second engagement value.

14. The method of claim 13, further comprising:
determining a third engagement value that indicates a third level of engagement associated with second content items that contain a link to a second set of content that is different than the first set of content;
wherein the second engagement value is different than the third engagement value.

15. The method of claim 11, further comprising:
determining a first number of times that users request the online resource after selecting content items of the first type;
determining a second number of times that users request the online resource after not selecting content items of the first type;
generating the first engagement value based on a ratio of the first number of times and the second number of times.

16. The method of claim 15, further comprising:
for a first set of requests, using the first engagement level;
for a second set of requests, using a second engagement level that is different than the first engagement level;
performing a comparison between a first performance of the first set of requests and a second performance of the second set of requests;
selecting a particular engagement level based on the comparison.

17. The method of claim 11, wherein:
the first type is one of text content items, dynamic content items, or third-party content items;
the second type is another of text content items, dynamic content items, or third-party content items.

18. The method of claim 11, wherein:
generating the first predictive user selection rate for the first content item comprises:
generating a first initial predictive user selection rate using a first prediction model that corresponds to the first type, and
modifying the initial predictive user selection rate based on the first engagement level to generate the first predictive user selection rate;
generating the second predictive user selection rate for the second content item comprises generating the second predictive user selection rate using a second prediction model that corresponds to the second type.

19. The method of claim 18, wherein the first prediction model is based on a first set of features and the second prediction model is based on a second set of features that is different than the first set of features.
